(19) United States
(12) Patent Application Publication
(10) Pub. No.: US 2025/0117910 A1
(43) Pub. Date: Apr. 10, 2025

(54) FIXED OBJECT DETECTOR, FIXED OBJECT DETECTION METHOD, AND RECORDING MEDIUM

(71) Applicant: Nuvoton Technology Corporation Japan, Kyoto (JP)

(72) Inventor: Takashi KAMIUNTEN, Kanagawa (JP)

(21) Appl. No.: 18/901,599

(22) Filed: Sep. 30, 2024

Related U.S. Application Data
(63) Continuation of application No. PCT/JP2023/011338, filed on Mar. 22, 2023.

(30) Foreign Application Priority Data
Mar. 31, 2022 (JP) 2022-059751

(51) Int. Cl. G06T 7/00; G06T 7/50; G06T 7/73; G06T 7/90

(52) U.S. Cl. CPC G06T 7/0002; G06T 7/50; G06T 7/73; G06T 7/90; G06T 2207/10016; G06T 2207/10024; G06T 2207/20061; G06T 2207/30168; G06T 2207/30204

(57) ABSTRACT

A fixed object detector includes: a capturing device; a fixed-object area information obtainer (a dirt area information obtainer) that searches for a fixed object candidate that is a candidate for a fixed object appearing in a video captured by the capturing device, and obtains a fixed-object area information item indicating coordinates of the fixed object candidate in the video, the fixed object having a fixed relative position with respect to the capturing device; a storage that stores therein the fixed-object area information item obtained; and an observer that determines that the coordinates indicated by the fixed-object area information item to be coordinates of the fixed object in the video and outputs a determination result, the coordinates indicated by the fixed-object area information item matching coordinates indicated by a past fixed-object area information item stored in the storage in past.

### CROSS REFERENCE TO RELATED APPLICATION

This is a continuation application of PCT International Application No. PCT/JP2023/011338 filed on Mar. 22, 2023, designating the United States of America, which is based on and claims priority of Japanese Patent Application No. 2022-059751 filed on Mar. 31, 2022. The entire disclosures of the above-identified applications, including the specifications, drawings and claims are incorporated herein by reference in their entirety.

### FIELD

The present disclosure relates to a fixed object detector, a fixed object detection method, and a recording medium.

### BACKGROUND

Importance of ensuring a view has been increasing in the use of a camera monitor system provided in a vehicle. For example, dirt that appears in a video captured by a camera makes a blind spot in a view of an operator. Furthermore, dirt may be a factor that impairs the safety of a vehicle in an automatic data acquisition system (ADAS). Accordingly, there has been an increasing demand for detecting adhering dirt and warning the operator or automatically cleaning the dirt.

Some mechanisms for detecting dirt that appears in a video captured by a camera have been proposed. For example, according to Patent Literature (PTL) 1, determination for a fixed object is made using a threshold of a brightness and a determination condition through a comparison with an adjacent small region, based on a brightness information item for each of small regions resulting from dividing a predetermined region in a captured video.

### CITATION LIST

### Patent Literature

PTL 1: Japanese Unexamined Patent Application Publication No. 2021-51381

### SUMMARY

### Technical Problem

However, such a conventional method as stated above may often lead to the occurrence of incorrect detection.

The present disclosure provides, for instance, a fixed object detector that can reduce occurrence of incorrect detection and improve a detection rate of an adhering fixed object.

### Solution to Problem

A fixed object detector according to an aspect of the present disclosure includes: a capturing device; a fixed-object area information obtainer that searches for a fixed object candidate that is a candidate for a fixed object appearing in a video captured by the capturing device, and obtains a fixed-object area information item indicating coordinates of the fixed object candidate in the video, the fixed object having a fixed relative position with respect to the capturing device; a storage that stores therein the fixed-object area information item obtained; and an observer that determines the coordinates indicated by the fixed-object area information item to be coordinates of the fixed object in the video and outputs a determination result, the coordinates indicated by the fixed-object area information item matching coordinates indicated by a past fixed-object area information item stored in the storage in past.

### Advantageous Effects

According to the present disclosure, a fixed object detector, for instance, that can reduce occurrence of incorrect detection and improve a detection rate of an adhering fixed object is provided.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 illustrates a configuration of a fixed object detector according to Embodiment 1 of the present disclosure.

FIG. 2 is an explanatory diagram of a dirt area information item, according to Embodiment 1 of the present disclosure.

FIG. 3 is an explanatory diagram of a combiner according to Embodiment 1 of the present disclosure.

FIG. 4 is a flowchart for an observer according to Embodiment 1 of the present disclosure.

FIG. 5 is a flowchart for the observer according to Embodiment 1 of the present disclosure.

FIG. 6 is a flowchart for the observer according to Embodiment 1 of the present disclosure.

FIG. 7 is a flowchart for the observer according to Embodiment 1 of the present disclosure.

FIG. 8 is a flowchart for the observer according to Embodiment 1 of the present disclosure.

FIG. 9 is explanatory diagram 1 of a dirt matching determination process according to Embodiment 1 of the present disclosure.

FIG. 10 is explanatory diagram 2 of the dirt matching determination process according to Embodiment 1 of the present disclosure.

FIG. 11 is explanatory diagram 3 of the dirt matching determination process according to Embodiment 1 of the present disclosure.

FIG. 12 illustrates a configuration of a dirt area information obtainer according to Embodiment 1 of the present disclosure.

FIG. 13 is an explanatory diagram of region division of a video, according to Embodiment 1 of the present disclosure.

FIG. 14 is an explanatory diagram of excluded areas that are excluded from observation by the observer according to Embodiment 1 of the present disclosure.

FIG. 15 is an explanatory diagram of excluded colors that are excluded from observation by the observer according to Embodiment 1 of the present disclosure.

FIG. 16 illustrates a configuration of a fixed object detector according to Embodiment 2 of the present disclosure.

FIG. 17 illustrates a configuration of a fixed object detector according to Embodiment 3 of the present disclosure.

FIG. 18 illustrates a configuration of a fixed object detector according to Embodiment 4 of the present disclosure.

FIG. 19 illustrates a configuration of a fixed-object area information obtainer according to Embodiment 5 of the present disclosure.

### DESCRIPTION OF EMBODIMENT

(Circumstances Leading to the Present Disclosure) Importance of ensuring a view has been increasing in the use of a camera monitor system provided in a vehicle. For example, dirt that appears in a video captured by a camera makes a blind spot in a view of an operator. Furthermore, dirt may be a factor that impairs the safety of a vehicle in an automatic data acquisition system (ADAS). Accordingly, there has been an increasing demand for detecting adhering dirt and warning the operator or automatically cleaning the dirt.

Some mechanisms for detecting dirt that appears in a video captured by a camera have been proposed. For example, according to PTL 1, determination for a fixed object is made using a threshold of a brightness and a determination condition through a comparison with an adjacent small region, based on a brightness information item for each of small regions resulting from dividing a predetermined region in a captured video.

However, with this method, a fixed object can be detected also in an environment such as dusk, but nevertheless, when a video captured by a capturing device is input which shows, for instance, sky or a road that has little change in brightness, incorrect detection may be made although a fixed object is not present.

The present disclosure is to reduce incorrect detection and to improve a detection rate for adhering dirt, by using a detector that detects a plurality of pieces of dirt that have unchanging brightness, a distance calculator that calculates a distance between detected coordinates, and a combiner that combines adjacent pieces of dirt into one.

The present disclosure reduces an incorrect detection rate, which is a rate at which a portion other than dirt adhering to a camera, such as sky or a road that shows little change in a video, is incorrectly determined.

By applying dirt detection according to the present disclosure, not only dirt, but also an adhering raindrop and a crack or a scratch present in a lens of a camera provided in a vehicle or a window glass can be detected.

### SUMMARY OF THE DISCLOSURE

A summary of the present disclosure is as follows. Specifically, a fixed object detector according to a first aspect includes: a capturing device; a fixed-object area information obtainer that searches for a fixed object candidate that is a candidate for a fixed object appearing in a video captured by the capturing device, and obtains a fixed-object area information item indicating coordinates of the fixed object candidate in the video, the fixed object having a fixed relative position with respect to the capturing device; a storage that stores therein the fixed-object area information item obtained; and an observer that determines the coordinates indicated by the fixed-object area information item to be coordinates of the fixed object in the video and outputs a determination result, the coordinates indicated by the fixed-object area information item matching coordinates indicated by a past fixed-object area information item stored in the storage in past.

Such a fixed object detector can determine whether the relative position of the fixed object candidate with respect to the capturing device has been continuously fixed, according to whether the coordinates match coordinates indicated by a stored fixed object area information obtained in the past. If the relative position with respect to the capturing device has been continuously fixed from the past, the fixed object candidate can be determined as a fixed object, for example. A fixed object is highly likely to be dirt to be removed or a crack or a scratch to be repaired, and thus a person in charge of the capturing device, for instance, can be notified of the presence of the fixed object by outputting a determination result. On the other hand, according to the above aspect, if the obtained fixed object area information item does not match a stored fixed object area information item obtained in the past, the fixed object candidate can be determined to be in a state in which its relative position with respect to the capturing device is temporarily fixed, and thus the fixed object candidate can be determined not to be a fixed object, for example. The fixed object candidate at this time may have been incorrectly detected. In this manner, an incorrectly detected fixed object candidate is prevented from being determined as a fixed object by determining whether a candidate has been continuously the same fixed object candidate in a time domain, and thus the occurrence of incorrect detection can be reduced and the detection rate for an adhering fixed object can be relatively improved.

For example, a fixed object detector according to a second aspect is the fixed object detector according to the first aspect which may further include: a distance calculator that calculates a distance between the coordinates of the fixed object candidate indicated by the fixed-object area information item and coordinates of another fixed object candidate indicated by another fixed-object area information item, the fixed object candidate and the other fixed object candidate simultaneously appearing in the video; and a combiner that updates, when the distance calculated by the distance calculator is less than a threshold, the coordinates indicated by the fixed-object area information item and the coordinates indicated by the other fixed-object area information item to updated coordinates indicated by a single fixed-object area information item, and in which the fixed-object area information item stored in the storage may be the single fixed-object area information item indicating the updated coordinates.

According to this, a plurality of fixed object area information items having a distance of a threshold or less, which may be derived from one fixed object candidate, can be treated as a single fixed object area information item.

For example, a fixed object detector according to a third aspect is the fixed object detector according to the first or second aspect which may further include: an adhering object notification device that notifies a user of the determination result output by the observer.

According to this, the adhering object notifier can notify a user (for example, a person in charge of a capturing device or a medium provided with the capturing device. An example of such a medium is a movable body such as a vehicle) of the determination result.

For example, a fixed object detector according to a fourth aspect is the fixed object detector according to any one of the first to third aspects in which the observer may execute: a matching determination process of determining whether the coordinates indicated by the fixed-object area information item match the coordinates indicated by the past fixed-object area information item stored in the past; a detection count recording process of making addition to a matching detection count of the fixed-object area information item indicating the coordinates determined to match in the matching determination process, and making subtraction from the matching detection count of the fixed-object area information item indicating the coordinates determined not to match in the matching determination process; a fixed-object area information confirmation process of determining coordinates indicated by a fixed-object area information item, a matching detection count of which exceeds a first threshold count, to be the coordinates of the fixed object in the video; and a fixed-object area information delete process of deleting a fixed-object area information item, a matching detection count of which is less than or equal to a second threshold count.

According to this, based on a matching detection count, a period from the past in which the fixed object candidate has been in a state in which the relative position thereof with respect to a capturing device is continuously fixed can be managed. When the matching detection count exceeds the first threshold count, the fixed object candidate is determined to be a fixed object, and a determination result can be output. The matching detection count is subjected to subtraction if coordinates of fixed object area information items do not match, and when the matching detection count has become less than or equal to the second threshold count, the fixed object area information item can be deleted as indicating a fixed object candidate that temporarily occurs due to incorrect detection, for instance. The second threshold count may be set to a relatively low count of zero to ten. By making such a setting, it is less likely to cause a problem, for instance, that a fixed object area information item that actually corresponds to a fixed object is deleted since the information item does not match a past fixed object area information item just once due to missed detection.

For example, a fixed object detector according to a fifth aspect is the fixed object detector according to the fourth aspect in which at least one of the first threshold count or the second threshold count may be different for each of regions that result from dividing the video.

According to this, for each of a plurality of regions resulting from dividing a video, the first threshold count according to how readily incorrect detection occurs and the second threshold count according to how readily missed detection occurs can be set.

For example, a fixed object detector according to a sixth aspect is the fixed object detector according to the first aspect in which the observer may infer the coordinates of the fixed object in the video, based on the past fixed-object area information item stored in the storage, and output an inference result as the determination result.

According to this, the inference result indicating coordinates of a fixed object in a video that are inferred based on a past fixed object area information item stored in a storage can be output as a determination result.

For example, a fixed object detector according to a seventh aspect is the fixed object detector according to any one of the first to sixth aspects in which the observer may execute a coordinate information determination process of determining whether the coordinates indicated by the fixed-object area information item are included in an excluded area that is preset in the video, and for the fixed-object area information item indicating the coordinates determined not to be included in the excluded area in the coordinate information determination process, the observer may determine whether the fixed-object area information item indicates the coordinates of the fixed object in the video.

According to this, whether to make determination on a fixed object area information item as to whether the coordinates indicated thereby are coordinates of a fixed object in a video can be individually set according to whether the coordinates are included in the preset excluded area in the video. For example, by not determining whether coordinates are of a fixed object in a video for a fixed object area information item indicating coordinates included in an excluded area preset in a video, a process resource for the determination can be reduced.

For example, a fixed object detector according to an eighth aspect is the fixed object detector according to any one of the first to seventh aspects in which the observer may execute a color determination process of determining whether a display color at the coordinates indicated by the fixed-object area information item in the video corresponds to an excluded color that is preset, and for the fixed-object area information item indicating the coordinates at which the display color in the video has been determined not to correspond to the excluded color in the color determination process, the observer may determine whether the fixed-object area information item indicates the coordinates of the fixed object in the video.

According to this, whether to make determination on a fixed object area information item as to whether the coordinates indicated thereby are coordinates of a fixed object in a video can be individually set according to whether the color corresponds to a present excluded color. For example, by not determining whether coordinates are of a fixed object in a video for a fixed object area information item indicating coordinates having a color corresponding to the present excluded color, a process resource for the determination can be reduced.

For example, a fixed object detector according to a ninth aspect is the fixed object detector according to any one of the first to eighth aspects in which the coordinates indicated by the fixed-object area information item may include one-end coordinates and other-end coordinates of the fixed object candidate, the one-end coordinates and the other-end coordinates being on a one-end side and another-end side in a predetermined direction, respectively, and when a distance between one-end coordinates indicated by one fixed-object area information item and one-end coordinates indicated by another fixed-object area information item is less than or equal to a one-end threshold and a distance between other-end coordinates indicated by the one fixed-object area information item and other-end coordinates indicated by the other fixed-object area information item is less than or equal to another-end threshold, coordinates indicated by the one fixed-object area information item may be determined to match coordinates indicated by the other fixed-object area information item.

According to this, whether two fixed object area information items match can be determined by using the one-end coordinates and the other-end coordinates.

For example, a fixed object detector according to a tenth aspect is the fixed object detector according to any one of the first to ninth aspects in which the coordinates indicated by the fixed-object area information item may include center coordinates that are coordinates at a center that bisects a line segment that connects a point on a one-end side of the fixed object candidate in a predetermined direction and a point on another-end side of the fixed object candidate in the predetermined direction, and when a distance between center coordinates indicated by one fixed-object area information item and center coordinates indicated by another fixed-object area information item is less than or equal to a center threshold, coordinates indicated by the one fixed-object area information item may be determined to match coordinates indicated by the other fixed-object area information item.

According to this, whether two fixed object area information items match can be determined by using the center coordinates.

For example, a fixed object detector according to an eleventh aspect is the fixed object detector according to any one of the first to eighth aspects in which the coordinates indicated by the fixed-object area information item may include one-end coordinates and other-end coordinates of the fixed object candidate, and center coordinates that are coordinates at a center that bisects a line segment that connects a point on a one-end side of the fixed object candidate in the predetermined direction and a point on another-end side of the fixed object candidate in the predetermined direction, the one-end coordinates and the other-end coordinates being on the one-end side and the other-end side in the predetermined direction, respectively, and when a distance between one-end coordinates indicated by one fixed-object area information item and one-end coordinates indicated by another fixed-object area information item is less than or equal to a one-end threshold, a distance between other-end coordinates indicated by the one fixed-object area information item and other-end coordinates indicated by the other fixed-object area information item is less than or equal to another-end threshold, and a distance between center coordinates indicated by the one fixed-object area information item and center coordinates indicated by the other fixed-object area information item is less than or equal to a center threshold, coordinates indicated by the one fixed-object area information item may be determined to match coordinates indicated by the other fixed-object area information item.

According to this, whether two fixed object area information items match can be determined by using the one-end coordinates, the other-end coordinates, and the center coordinates.

For example, a fixed object detector according to a twelfth aspect is the fixed object detector according to any one of the first to eleventh aspects which may further include: an image quality adjusting device that receives input of an original video captured by the capturing device, and outputs a video having image quality adjusted to increase a probability of finding one or more fixed object candidates that include the fixed object candidate.

According to this, a probability for finding a fixed object candidate can be improved.

For example, a fixed object detector according to a thirteenth aspect is the fixed object detector according to any one of the first to twelfth aspects which may further include: a remover that removes the fixed object, based on the determination result output.

According to this, a fixed object that is continuously present can be removed by the remover.

For example, a fixed object detector according to a fourteenth aspect is the fixed object detector according to any one of the first to thirteenth aspects which may further include: a reducer that reduces the video; a feature detector that detects a feature from a reduced video resulting from the reducer reducing the video; a feature storage that stores therein one or more features; a cumulative adder that adds the feature detected by the feature detector and a prestored feature that is stored in advance in the feature storage, and stores a result of adding the feature detected and the prestored feature into the feature storage as an added feature; a binarizer that binarizes the added feature stored; a noise remover that removes noise included in data of the added feature binarized, by reducing and expanding the data of the added feature binarized; and a labeler that generates the fixed-object area information item, based on the data of the added feature binarized from which the noise has been removed.

According to this, the reducer, the feature detector, the feature storage, the cumulative adder, the binarizer, the noise remover, and the labeler can generate a fixed object area information item from the video.

For example, a fixed object detector according to a fifteenth aspect is the fixed object detector according to any one of the first to fourteenth aspects in which the fixed object may be dirt adhering to a light-transmitting member, the dirt being within a capturing area of the capturing device, and the fixed object candidate may be a candidate for the dirt.

According to this, occurrence of incorrect detection can be reduced and a detection rate for detecting adhering dirt can be relatively improved.

For example, a fixed object detector according to a sixteenth aspect is the fixed object detector according to any one of the first to fourteenth aspects in which the fixed object may be a raindrop on a light-transmitting member, the raindrop being within a capturing area of the capturing device, and the fixed object candidate may be a candidate for the raindrop.

According to this, occurrence of incorrect detection can be reduced and a detection rate for detecting an adhering raindrop can be relatively improved.

For example, a fixed object detector according to a seventeenth aspect is the fixed object detector according to the sixteenth aspect which may further include: a remover that removes the fixed object, based on the determination result output, and in which the remover may be a wiper device that removes the raindrop.

According to this, a raindrop that is continuously present can be removed by the wiper device.

For example, a fixed object detector according to an eighteenth aspect is the fixed object detector according to any one of the first to fourteenth aspects in which the fixed object may be a defect that includes at least one of a crack or a scratch generated in a light-transmitting member, the at least one of the crack or the scratch being within a capturing area of the capturing device, and the fixed object candidate may be a candidate for the defect.

According to this, occurrence of incorrect detection can be reduced and a detection rate for detecting an occurring defect can be relatively improved.

For example, a fixed object detector according to a nineteenth aspect is the fixed object detector according to any one of the first to eighteenth aspects which may further include: a marker attached at a position corresponding to designated coordinates in the video; a position tilt detector that measures a difference between the designated coordinates and coordinates of the marker indicated by the determination result output by the observer, the marker being the fixed object; a position tilt correction device that corrects at least one of a position or a tilt of the video, based on the difference measured by the position tilt correction device; and a display device that displays the video having the position and the tilt at least one of which has been corrected by the position tilt correction device.

According to this, how much coordinates indicated by a fixed object area information item of a marker provided at a position corresponding to the designated coordinates, which are generated when the marker is detected as a fixed object, deviate from the designated coordinates can be calculated by obtaining a difference. A deviation corresponding to the difference can be changed into an appropriate state by correcting at least one of the position or a tilt of a video, and the resultant video can be displayed on a display device.

For example, a fixed object detector according to a twentieth aspect is the fixed object detector according to any one of the first to nineteenth aspects which may further include: a predictor that detects coordinates of a portion in which an edge shape that appears in the video captured by the capturing device is different from a predetermined shape; and a determiner that determines the determination result is correct when the coordinates determined to be the coordinates of the fixed object in the determination result obtained by the observer match the coordinates detected by the predictor, and in which the observer may output the determination result determined to be correct by the determiner.

According to this, when coordinates indicated by a fixed object area information item corresponding to a fixed object in the determination result match coordinates predicted to correspond to a fixed object based on an edge shape that appears in a video being different from a predetermined shape, a determination result is assumed to be correct and can be output. In other words, according to this aspect, by verifying a determination result using coordinates predicted to correspond to a fixed object based on an edge shape that appears in a video being different from a predetermined shape, the accuracy of the determination result can be guaranteed.

For example, a fixed object detector according to a twenty first aspect is the fixed object detector according to any one of the first to twentieth aspects which may further include: a reducer that reduces the video; a feature detector that detects a feature from a reduced video resulting from the reducer reducing the video; a feature storage that stores therein one or more features; a cumulative adder that adds the feature detected by the feature detector and a prestored feature that is stored in advance in the feature storage, and stores a result of adding the feature detected and the prestored feature into the feature storage as an added feature; a binarizer that binarizes the added feature stored; and a straight line detector that detects, from data of the added feature binarized, coordinates of the fixed object candidate in a straight shape in the video, by using Hough transform that is a transform algorithm.

According to this, the reducer, the feature detector, the feature storage, the cumulative adder, the binarizer, and the straight line detector can generate coordinates in a video of a fixed object in a straight line from the video.

Specifically, a fixed object detection method according to a twenty second aspect is a fixed object detection method executed with use of a computer, the fixed object detection method including: searching for a fixed object candidate that is a candidate for a fixed object appearing in a video captured by a capturing device, and obtaining a fixed-object area information item indicating coordinates of the fixed object candidate in the video, the fixed object having a fixed relative position with respect to the capturing device; storing the fixed-object area information item obtained; and determining that the coordinates indicated by the fixed-object area information item to be coordinates of the fixed object in the video and outputting a determination result, the coordinates indicated by the fixed-object area information item matching coordinates indicated by a past fixed-object area information item stored in past.

With such a fixed object detection method, similar effects to those yielded by the fixed object detector stated above can be yielded.

A recording medium according to a twenty third aspect is a non-transitory computer-readable recording medium having recorded thereon a program for causing the computer to execute the fixed object detection method described above.

Such a recording medium can yield similar effects to those yielded by the fixed object detector according to the above by using a computer.

Hereinafter, embodiments of the present disclosure are to be described with reference to the drawings.

### Embodiment 1

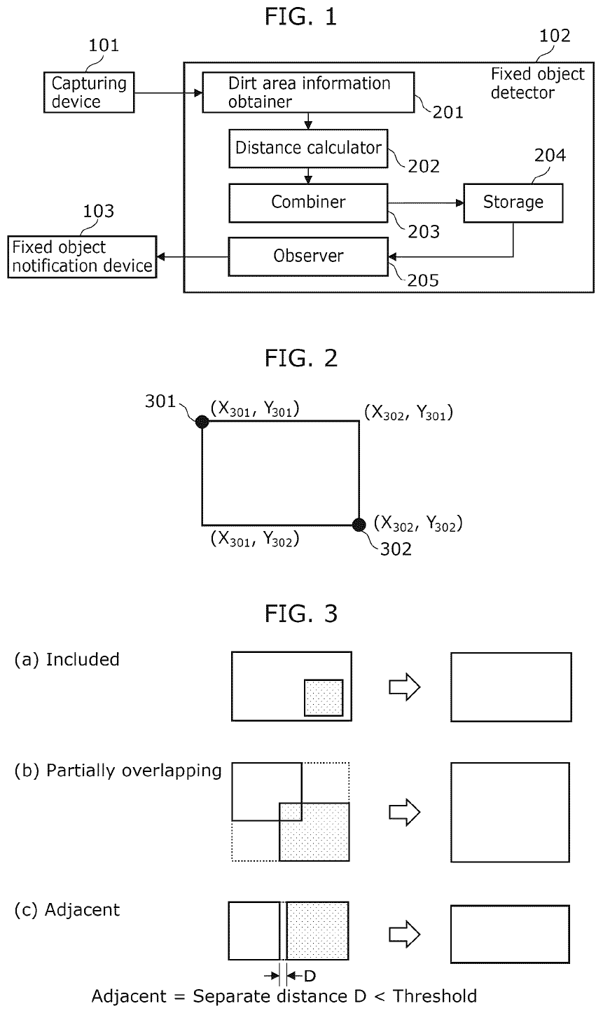

A description is given with reference to a configuration diagram in FIG. 1 that illustrates an entire configuration of a camera monitor system that is provided in a vehicle and includes a fixed object detector according to Embodiment 1 of the present disclosure.

As illustrated in FIG. 1, the camera monitor system includes capturing device 101 provided in an orientation to capture images of the rear or the lateral side of the vehicle, fixed object detector 102 that detects dirt that is an example of a fixed object from a video captured by capturing device 101, and fixed object notification device 103 that notifies an operator of the vehicle of the presence of dirt detected by fixed object detector 102.

Here, capturing device 101 includes an image sensor that has a light receiving element, and is an analog video camera or a digital video camera that transmits video signals by using analog or digital signals.

The destination of notification made by fixed object notification device 103 may not be an operator, but may be a cleaning machine that cleans a lens portion included in capturing device 101. Accordingly, when an adhering object such as dirt (or stated differently, a fixed object) is adhering to the lens, the adhering object can be automatically cleaned. Similarly, when the capturing device is installed in an orientation for capturing images of a window, in order to remove dirt adhering to the window, it is possible to notify a cleaning machine for the window of the dirt, and cause the cleaning machine to automatically clean the window.

Fixed object detector 102 is implemented by executing a predetermined program with use of a processor and memory. Fixed object detector 102 includes dirt area information obtainer 201 that searches for a dirt candidate from a video input from capturing device 101 and obtains a coordinate information item of the candidate, distance calculator 202 that calculates a distance between dirt and dirt based on a dirt area information item obtained by dirt area information obtainer 201 (an example of fixed-object area information item), combiner 203 that combines pieces of adjacent dirt into a single piece of dirt from the distance obtained (calculated) by distance calculator 202, and calculates a new dirt area information item, storage 204 that temporarily stores, into a storage device, the new dirt area information item obtained by combiner 203, and observer 205 that compares a past dirt area information item stored in storage 204 with a newly detected dirt area information item and ultimately determines a dirt area information item that is continuously present, as a dirt area information item that is present.

A dirt area information item obtained by dirt area information obtainer 201 is to be described with reference to FIG. 2.

A dirt area information item is represented by X and Y coordinates at point 301 and point 302 on a virtual XY coordinate plane parallel to a video surface, and a quadrilateral area that can be drawn by these two points is shown as an area in which dirt is adhering.

Specifically, when coordinates of point 301 are (X₃₀₁, Y₃₀₁) and coordinates of point 302 are (X₃₀₂, Y₃₀₂), a quadrilateral that can be drawn by connecting coordinates of four points (X₃₀₁, Y₃₀₁), (X₃₀₁, Y 302), (X₃₀₂, Y₃₀₁), and (X₃₀₂, Y₃₀₂) is defined as a dirt area.

Combiner 203 is to be described with reference to FIG. 3.

Distance calculator 202 calculates a distance between dirt and dirt, and combines regions to obtain one dirt area information item when one of the following relations is satisfied: a relation in which one piece of dirt includes another piece of dirt ((a) of FIG. 3), a relation in which one piece of dirt partially overlaps another piece of dirt ((b) of FIG. 3), or a relation in which separate distance D between one piece of dirt and another piece of dirt is less than a predetermined threshold so that the pieces of dirt are adjacent to each other ((c) of FIG. 3).

A distance between pieces of dirt may be calculated again from a new dirt area information item obtained by combining regions, and combiner 203 may further combine regions from the result. Such a series of processes may be repeated for plural times.

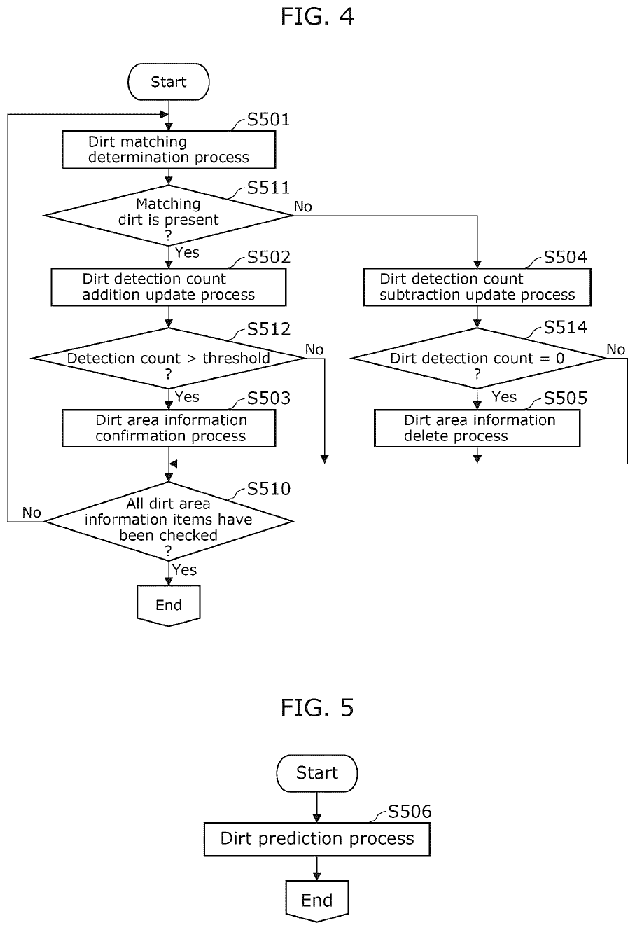

Determination of continuously present dirt by observer 205 is to be described with reference to the flowchart illustrated in FIG. 4.

A dirt matching determination process (S501) of fetching one dirt area information item detected in the past, and determining whether a dirt area information item that matches a newly detected dirt area information item is present is performed. Specifically, whether matching dirt is present is determined (S511).

When determination that matching dirt is present is made in this process (Yes in S511), a dirt detection count addition update process (S502) of adding one to a dirt detection count is performed. Then, the dirt detection count is compared with a threshold (S512). As a result, when the dirt detection count is greater than the predetermined threshold (Yes in S512), a dirt area information confirmation process (S503) of confirming that the dirt area information item indicates present dirt (that is, not a dirt candidate, but dirt) is performed. When the dirt detection count is less than or equal to the predetermined threshold (No in S512), step S503 is skipped.

On the other hand, as a result of the determination in the dirt matching determination process, when the determination result shows non-matching (Yes in S511), a dirt detection count subtraction update process (S504) of subtracting one from the dirt detection count is performed. Then, the dirt detection count is compared with the threshold (S514). Here, the threshold is 0. As a result, when the dirt detection count is 0 (Yes in S514), a dirt area information delete process (S505) of deleting a dirt area information item as a dirt area information item indicating a non-existing dirt is performed. When the dirt detection count is greater than the predetermined threshold of 0 (No in S514), step S505 is skipped.

All the processes are performed on all dirt area information items. Thus, whether all the dirt area information items have been checked is determined (S510), and when it is determined that all the dirt area information items have not been checked (No in S510), the processing returns to step S501 and the same processing is repeated on another dirt area information item. When all the information items are determined to be checked (Yes in S510), the processing ends.

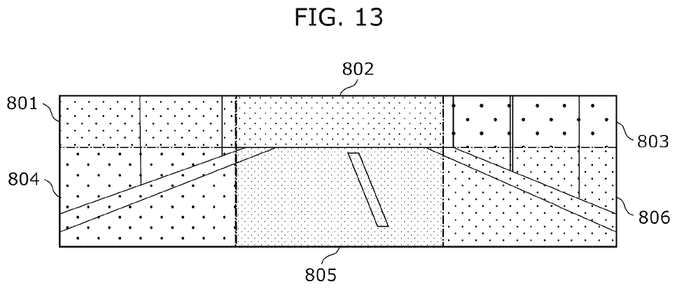

Note that the threshold for confirming dirt is not necessarily constant, and as shown in FIG. 13, for example, a video may be divided into a plurality of regions (for example, six regions of region 801 to region 806), and the threshold may be changed for each of the regions.

For example, by setting a high threshold for region 802 that largely includes sky, incorrect detection is reduced by taking time to detect dirt in this region. On the other hand, dirt is readily detected in region 801 and region 803 that largely include buildings, and thus time for detecting dirt in such regions can be decreased by setting a low threshold for such regions.

Determination of another piece of dirt by observer 205 is to be described with reference to the flowchart illustrated in FIG. 5.

A dirt prediction process (S506) of inferring a coordinate information item that indicates coordinates of present dirt from past dirt area information items accumulated in storage 204 and confirming the coordinate information item as indicating present dirt is performed.

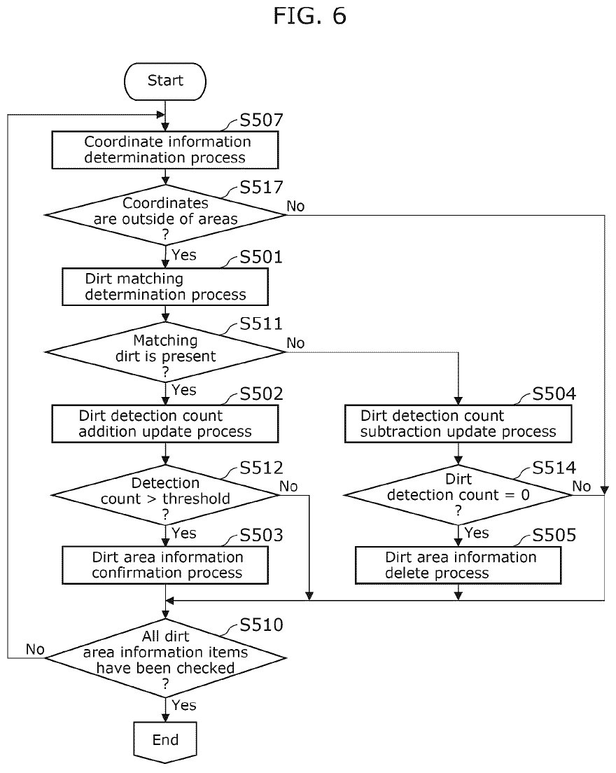

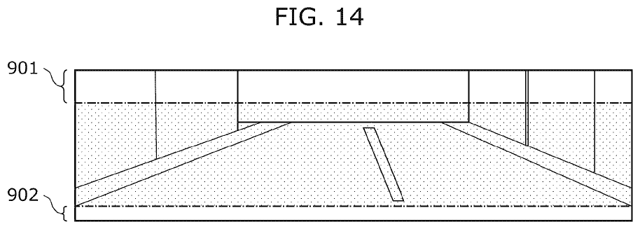

Determination of another piece of dirt continuously present by observer 205 is to be described with reference to the flowchart illustrated in FIG. 6 and FIG. 14. Note that in the flowchart illustrated in FIG. 6, the same processes are given with the same signs as those in FIG. 4, and overlapping description is omitted.

A coordinate information determination process (S507) of fetching one dirt area information item detected in the past and determining whether the Y coordinate (a coordinate in the vertical direction on the paper surface) in the lower right indicated by the dirt area information item is outside of upper excluded area 901 and furthermore, the Y coordinate in the upper left indicated by the dirt area information item is outside of lower excluded area 902 is performed. Stated differently, it is determined whether both of those coordinates are outside of the excluded areas (S517). When it is determined by the coordinate information determination process that the dirt area information item indicates the coordinates are out of the excluded areas (Yes in S517), a dirt matching determination process (S501) of determining whether there is a dirt area information item that matches a newly detected first area information item is performed. The processes thereafter are as described with reference to FIG. 4. When it is determined that there is a matching dirt area information item in this process, a dirt detection count addition update process (S502) of adding one to the dirt detection count is performed. When the dirt detection count is greater than or equal to the predetermined threshold as a result of the process, a dirt area information confirmation process (S503) of confirming that a dirt area information item indicates present dirt is performed.

On the other hand, as a result of the dirt matching determination process (S501), when the determination result shows non-matching, a dirt detection count subtraction update process of subtracting one from the dirt detection count subtraction update process (S504) of subtracting one from the dirt detection count is performed. As a result, when the dirt detection count has reached 0, a dirt area information delete process (S505) of deleting a dirt area information item as the dirt area information item indicating non-existing dirt is performed.

All the processes are performed on all dirt area information items.

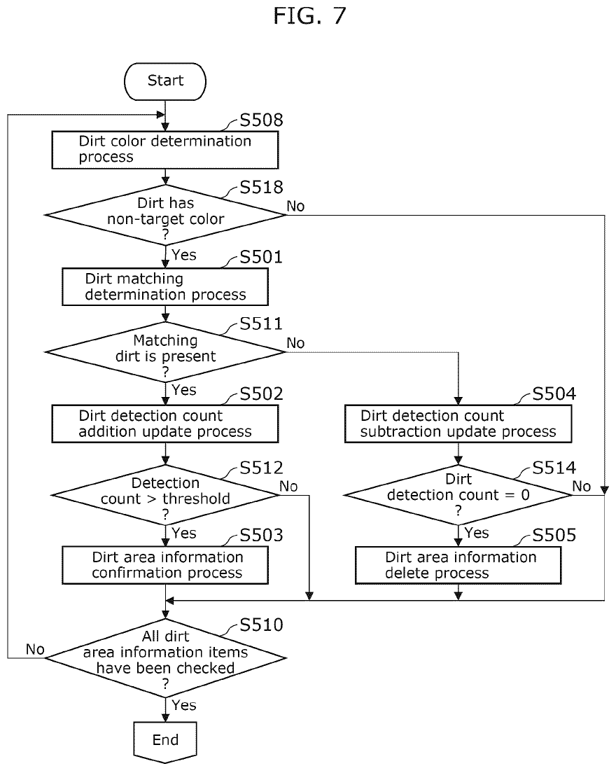

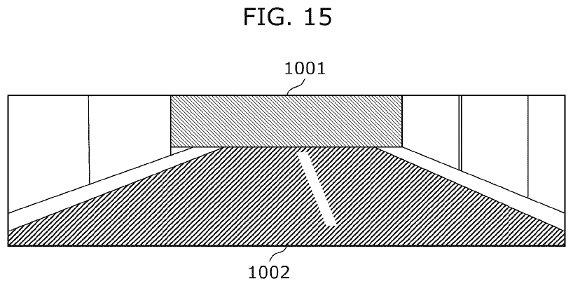

Determination of another piece of dirt continuously present by observer 205 is to be described with reference to the flowchart illustrated in FIG. 7 and FIG. 15. Note that in the flowchart illustrated in FIG. 7, the same processes as those in FIG. 4 are given with the same signs, and overlapping description is omitted.

Here, a dirt color information item is added to a dirt area information item.

One dirt area information item detected in the past is fetched, and a dirt color information item is obtained. A dirt color determination process (S508) of determining whether dirt color information item matches one of excluded color 1001 or excluded color 1002 is performed. Stated differently, it is determined whether a displayed color at coordinates in a video does not correspond to the excluded colors set in advance (S518). When a dirt color information item is determined not to indicate the excluded colors by the dirt color information determination process (Yes in S518), the dirt matching determination process of determining whether a dirt area information item that matches a newly detected first area information item is present is performed (S501). The processes thereafter are as described with reference to FIG. 4. When the information items are determined to be matching in this process, the dirt detection count addition update process (S502) of adding one to the dirt detection count is performed. When the dirt detection count has become greater than or equal to the predetermined threshold as a result of the process, the dirt area information confirmation process (S503) of confirming that the dirt area information item indicates present dirt is performed.

On the other hand, as a result of the dirt matching determination process (S501), when the determination result shows non-matching, the dirt detection count subtraction update process (S504) of subtracting one from the dirt detection count is performed. As a result, when the dirt detection count has reached 0, the dirt area information delete process (S505) of deleting a dirt area information item as the dirt area information item indicating non-existing dirt is performed.

All the processes are performed on all dirt area information items.

Note that excluded colors 1001 and 1002 are assumed to be two colors including the color of average sky in a sunny day and the color of average asphalt, but three or more excluded colors may be adopted assuming that various colors may be shown according to weather and time.

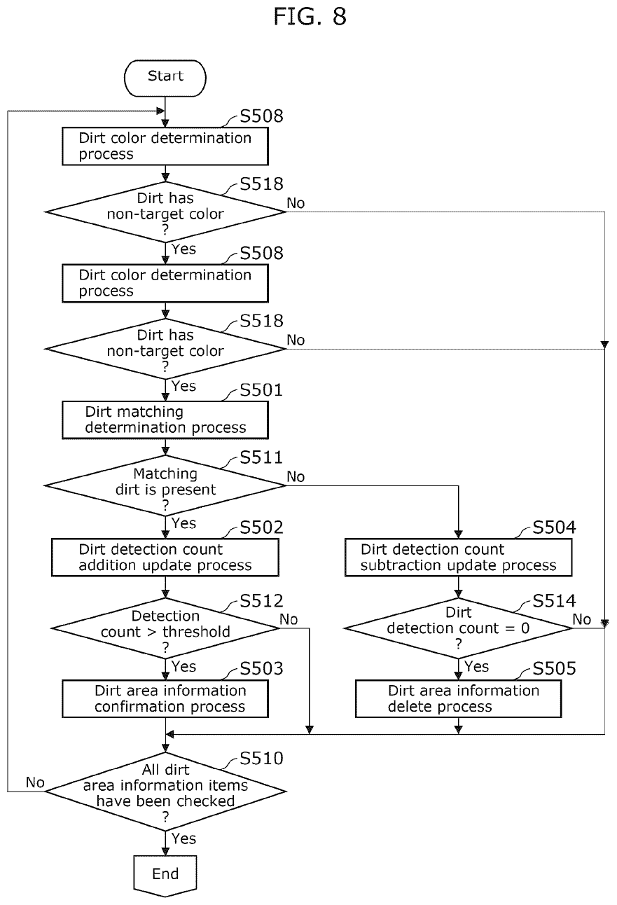

Determination of another piece of dirt continuously present by observer 205 is to be described with reference to the flowchart illustrated in FIG. 8, FIG. 14, and FIG. 15. Note that in the flowchart illustrated in FIG. 8, the same processes as those in FIG. 4 are given with the same signs, and overlapping description is omitted.

Also here, a dirt color information item is added to a dirt area information item.

The coordinate information determination process (S507) of fetching one dirt area information item detected in the past and determining whether the Y coordinate in the lower right indicated by the dirt area information item is present outside of upper excluded area 901 and furthermore, the Y coordinate in the upper left indicated by the dirt area information item is present outside of lower excluded area 902 is performed. When it is determined by the coordinate information determination process that the dirt area information item indicates coordinates outside of the excluded areas, a dirt color information item is further obtained. The dirt color determination process (S508) of determining whether a dirt color information item matches at least one of excluded color 1001 or excluded color 1002 is performed. When it is determined by the dirt color information determination process that the dirt color information item is not an excluded color, the dirt matching determination process (S501) of determining whether a dirt area information item that matches a newly detected first area information item is present is performed. The processes thereafter are as described with reference to FIG. 4. When the information items are determined to match in this process, a dirt detection count addition update process (S502) of adding one to the dirt detection count is performed. When the dirt detection count has become greater than or equal to the predetermined threshold as a result of the process, the dirt area information confirmation process (S503) of confirming that a dirt area information item indicates present dirt is performed.

On the other hand, as a result of the dirt matching determination process (S501), when the determination result shows non-matching, the dirt detection count subtraction update process (S504) of subtracting one from the dirt detection count is performed. As a result, when the dirt detection count has reached 0, the dirt area information delete process (S505) of deleting a dirt area information item as the dirt area information item indicating non-existing dirt is performed.

All the processes are performed on all dirt area information items.

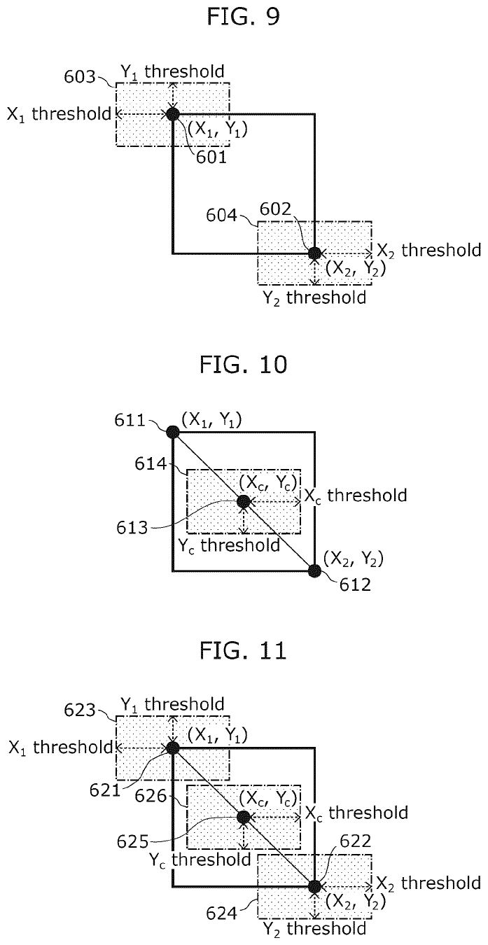

The dirt matching determination process is to be described with reference to FIG. 9.

A dirt area information item includes a coordinate information item of two points as described above. Matching determination region 603 that ranges from (X₁−X₁ threshold) to (X₁+X₁ threshold) and (Y₁−Y₁ threshold) to (Y₁+Y₁ threshold) is provided for point 601 shown by coordinates (X₁, Y₁) indicated by a dirt area information item detected in the past. Matching determination region 604 that ranges from (X₂−X₂ threshold) to (X₂+X₂ threshold) and (Y₂−Y₂ threshold) to (Y₂+Y₂ threshold) is provided for point 602 shown by coordinates (X₂, Y₂). When a coordinate information item of a dirt area information item newly detected indicates coordinates within matching determination regions 603 and 604 (that is, the difference is less than or equal to the threshold), the dirt is determined to be the same.

In addition, another dirt matching determination is to be described with reference to FIG. 10.

A dirt area information item includes a coordinate information item of one point. Matching determination region 614 that ranges from (X_{c}−X_{c} threshold) to (X_{c}+X_{c} threshold) and from (Y_{c}−Y_{c} threshold) to (Y_{c}+Y_{c} threshold) is provided for point 613 shown by center coordinates (X_{c}, Y_{c}) between two points that are point 611 shown by coordinates (X₁, Y₁) indicated by a dirt area information item detected in the past and point 612 shown by coordinates (X₂, Y₂). When the center point between two points indicated by a dirt area information item newly detected indicates coordinates within matching determination region 614 (that is, the difference is the threshold or less), the dirt is determined to be the same.

Another dirt matching determination is further described with reference to FIG. 11.

A dirt area information item includes a coordinate information item of three points. Matching determination region 623 that ranges from (X₁−X₁ threshold) to (X₁+X₁ threshold) and (Y₁−Y₁ threshold) to (Y₁+Y₁ threshold) is provided for point 621 shown by coordinates (X₁, Y₁) indicated by a dirt area information item detected in the past. Matching determination region 624 that ranges from (X₂−X₂ threshold) to (X₂+X₂ threshold) and (Y₂−Y₂ threshold) to (Y₂+Y₂ threshold) is provided for point 622 shown by coordinates (X₂, Y₂). In addition, matching determination region 626 that ranges from (X_{c}−X_{c} threshold) to (X_{c}+X_{c} threshold) and from (Y_{c}−Y_{c} threshold) to (Y_{c}+Y_{c} threshold) is provided for point 625 shown by center coordinates (X_{c}, Y_{c}) between two points that are point 621 and point 622. When a coordinate information item indicated by a dirt area information item newly detected is within the range of matching determination region 623 or 624 or the range of matching determination region 626, the dirt is determined to be the same.

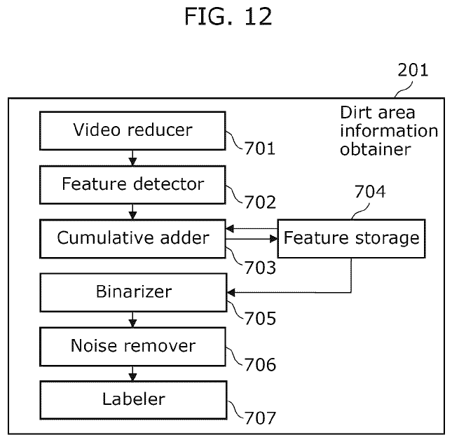

Dirt area information obtainer 201 is to be described with reference to FIG. 12.

Dirt area information obtainer 201 includes video reducer 701 that reduces a video captured by capturing device 101, feature detector 702 that detects a feature from video data reduced by video reducer 701, cumulative adder 703 that adds a result obtained by feature detector 702 and a feature stored in feature storage 704, feature storage 704 that stores, into a storage device, a cumulative feature calculated by cumulative adder 703, binarizer 705 that binarizes the cumulative feature stored into the storage device by feature storage 704, noise remover 706 that removes noise by reducing or expanding binarized data by binarizer 705, and labeler 707 that obtains a dirt area information item from the data obtained by noise remover 706.

As described above, Embodiment 1 yields advantageous effects of reducing, in dirt detection, an incorrect detection rate at which a portion such as sky or a road other than dirt is incorrectly determined as dirt.

By using such mechanisms, as a fixed object, not only dirt used as an example in the above, but also a fixed object such as a raindrop and yet more, cracks and scratches in a lens and window glass can be detected.

### Embodiment 2

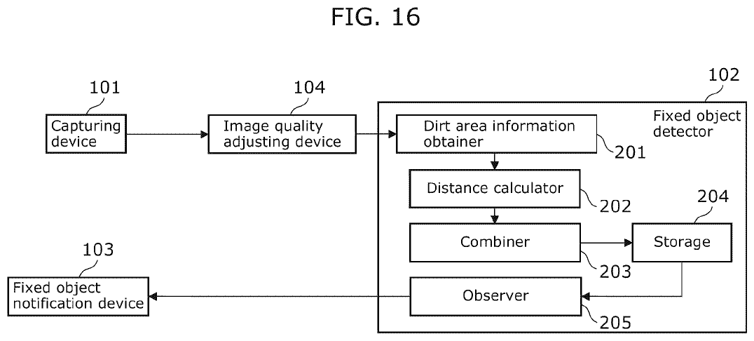

A description is given with reference to a configuration diagram in FIG. 16 that illustrates an entire configuration of a camera monitor system provided in a vehicle according to Embodiment 2 of the present disclosure. Note that in the dirt detector illustrated in FIG. 16, elements having the same functions as those of the elements in FIG. 1 used to describe Embodiment 1 are given with the same signs, and overlapping description is omitted.

As illustrated in FIG. 16, the camera monitor system includes capturing device 101 provided in an orientation to capture images of the rear or the lateral side of the vehicle, image quality adjusting device 104 that changes image quality of a video captured by capturing device 101, fixed object detector 102 that detects dirt from a video output by image quality adjusting device 104, and fixed object notification device 103 that notifies an operator of the presence of adhering dirt detected by fixed object detector 102.

Image quality adjusting device 104 has functions for, for instance, tone correction for adjusting the quality of a video input by capturing device 101, color balance adjustment, contrast correction, tone curve adjustment, gamma correction, and edge enhancement, posterizes a video and enhances edges in the video by using such functions, and corrects the video to obtain a video from which dirt can be readily detected.

As described above, Embodiment 2 can yield advantageous effects of improving accuracy of dirt detection by dirt area information obtainer 201, and reducing an incorrect detection rate at which a portion such as sky and a road other than dirt adhering to a camera is incorrectly detected more than Embodiment 1. Conversely, undetectable dirt can also be made detectable.

### Embodiment 3

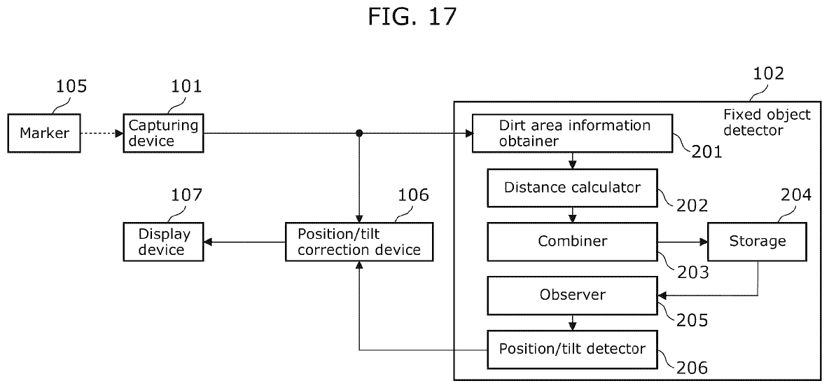

A description is given with reference to a configuration diagram in FIG. 17 that illustrates an entire configuration of a camera monitor system provided in a vehicle according to Embodiment 3 of the present disclosure. Note that in the dirt detector illustrated in FIG. 17, elements having the same functions as those of the elements in FIG. 1 used to describe Embodiment 1 are given with the same signs, and overlapping description is omitted.

In FIG. 17, the camera monitor system includes marker 105 that includes two or more sets of coordinates intentionally provided and fixed at designated coordinates, capturing device 101 that is provided in an orientation that allows images of the rear or lateral side of a vehicle to be captured and captures a video that includes marker 105, fixed object detector 102 that detects the marker as a fixed object from the video captured by capturing device 101, position tilt correction device 106 that corrects a position and an angle of an input video according to information items of a position and a tilt notified from fixed object detector 102, and display device 107 that displays a video resulting from position tilt correction device 106 correcting the video from capturing device 101.

Fixed object detector 102 includes dirt area information obtainer 201 that searches for a dirt candidate from a video input from capturing device 101 and obtains a coordinate information item of the candidate, distance calculator 202 that calculates a distance between dirt and dirt based on a dirt area information item obtained by dirt area information obtainer 201, combiner 203 that combines adjacent pieces of dirt into a single piece of dirt from the distance obtained by distance calculator 202 and calculates a new dirt area information item, storage 204 that temporarily stores, into a storage device, the new dirt area information item obtained by combiner 203, observer 205 that compares a past dirt area information item stored in storage 204 with a newly detected dirt area information item and determines a dirt area information item that is continuously present, as an ultimately present dirt area information item, and position tilt detector 206 that compares a dirt area information item of marker 105 as a fixed object detected by observer 205 with a supposed dirt area information item of marker 105, and calculates a difference between the positions thereof and a difference between the angles thereof.

As described above, according to Embodiment 3, deviations of the tilt and the position of a camera caused when the camera is attached at a factory, for instance, can be automatically corrected. Alternatively, deviations of the tilt and the position of a camera caused while an operator is using the camera can be corrected with a fixed object being attached by the operator at a designated position.

### Embodiment 4

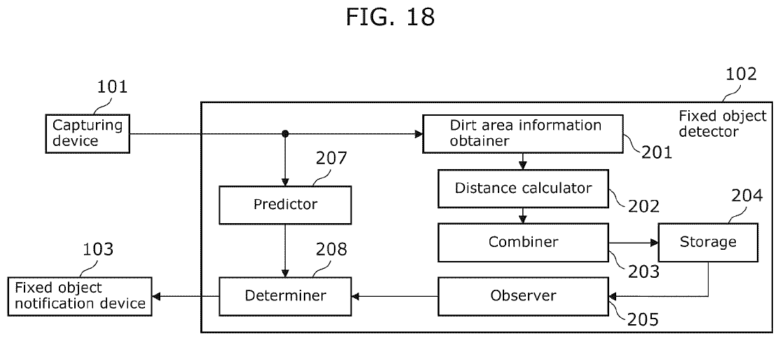

A description is given with reference to a configuration diagram in FIG. 18 that illustrates an entire configuration of a camera monitor system provided in a vehicle according to Embodiment 4 of the present disclosure. Note that in the dirt detector illustrated in FIG. 18, elements having the same functions as those of the elements in FIG. 1 used to describe Embodiment 1 are given with the same signs, and overlapping description is omitted.

As illustrated in FIG. 18, the camera monitor system includes capturing device 101 provided in an orientation to capture images of the rear or the lateral side of the vehicle, fixed object detector 102 that detects dirt from a video captured by capturing device 101, and fixed object notification device 103 that notifies an operator of the presence of dirt detected by fixed object detector 102.

Fixed object detector 102 includes dirt area information obtainer 201 that searches for a dirt candidate from a video input from capturing device 101 and obtains a coordinate information item of the candidate, distance calculator 202 that calculates a distance between dirt and dirt based on a dirt area information item obtained by dirt area information obtainer 201, combiner 203 that combines adjacent pieces of dirt into a single piece of dirt from the distance obtained by distance calculator 202 and calculates a new dirt area information item, storage 204 that temporarily stores, into a storage device, the new dirt area information item obtained by combiner 203, observer 205 that compares a past dirt area information item stored in storage 204 with a newly detected dirt area information item and determines a dirt area information item that is continuously present, as an ultimately present dirt area information item, predictor 207 that detects a coordinate information item of a portion that does not have a shape expected to be an edge in a video (for example, a portion that is a missing portion of an edge line of a vehicle) in a video captured by capturing device 101, and determiner 208 that compares the dirt area information item obtained by observer 205 and the coordinate information item obtained by predictor 207 and when the information items detected by the two elements indicate the same coordinates, confirms that the coordinates indicate dirt.

As described above, Embodiment 4 can yield advantageous effects of improving accuracy of dirt detection by dirt area information obtainer 201, and reducing an incorrect detection rate at which a portion such as sky and a road other than dirt adhering to a camera is incorrectly detected more than Embodiment 1.

### Embodiment 5

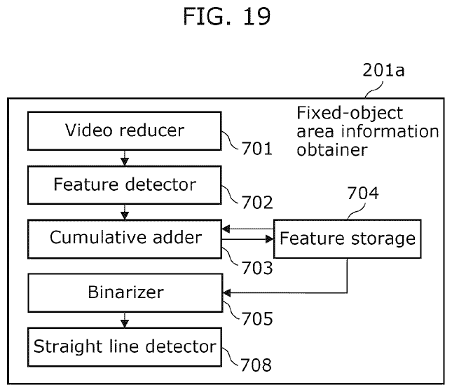

A description is given with reference to a configuration diagram in FIG. 19 that illustrates an entire configuration of a camera monitor system provided in a vehicle according to Embodiment 5 of the present disclosure. Note that in fixed-object area information obtainer 201a illustrated in FIG. 19, elements having the same functions as those of the elements in FIG. 12 used to describe Embodiment 1 are given with the same signs, and overlapping description is omitted.

Fixed-object area information obtainer 201a includes video reducer 701 that reduces a video captured by capturing device 101, feature detector 702 that detects a feature from video data resulting from the reduction by video reducer 701, feature storage 704 that stores therein a feature, cumulative adder 703 that adds the feature stored in feature storage 704 and the feature detected by feature detector 702, binarizer 705 that binarizes the feature stored in feature storage 704, and straight line detector 708 that detects a straight line from data resulting from the binarization by binarizer 705 by using Hough transform that is a transform algorithm.

As described above, according to Embodiment 5, a white line that divides a road into lanes can be detected by using some of the functions of the dirt detector, similarly to a fixed object such as dirt.

### Other Embodiments

The above has described the fixed object detector and others according to the present disclosure, based on the embodiments and variations, yet the present disclosure is not limited to the above embodiments. For example, the present disclosure may also include embodiments as a result of adding, to the embodiments, various modifications that may be conceived by those skilled in the art, and embodiments obtained by combining elements and functions in the embodiments in any manner without departing from the gist of the present disclosure.

For example, processing elements such as the fixed object detector and the dirt area information obtainer may include one or more electronic circuits. The one or more electronic circuits may each be a general circuit or a dedicated circuit. The one or more electronic circuits may include a semiconductor device, an integrated circuit (IC), or a large-scale integrated circuit (LSI), for instance. An IC or an LSI may be integrated into a single chip or into a plurality of chips. Here, such a circuit is referred to as an IC or an LSI, but may be referred to differently depending on the degree of integration, so as to be referred to as a very large-scale integrated circuit (VLSI) or an ultra large-scale integrated circuit (ULSI). A field programmable gate array (FPGA) that is programmed after an LSI is manufactured can be used for the same purpose.

General and specific aspects of the present disclosure may be implemented using a system, a device, a method, an integrated circuit, or a computer program. Alternatively, the aspects may be implemented by a non-transitory computer-readable recording medium such as an optical disk, a hard disk device (HDD), or a semiconductor memory in which the computer program is stored. The aspects may be implemented by any combination of systems, devices, methods, integrated circuits, computer programs, or recording media.

### INDUSTRIAL APPLICABILITY

The present disclosure can increase reliability of a device and enables accurate cleaning of a capturing device by decreasing an incorrect detection rate for a detectable fixed object in a video captured by the capturing device.

The fixed object is not limited to dirt, but a raindrop, for instance, can also be detected.

Furthermore, the position and the angle for attaching a capturing device can be detected and corrected by intentionally providing a fixed object at predetermined coordinates.

1. A fixed object detector comprising:
a capturing device;
a fixed-object area information obtainer that searches for a fixed object candidate that is a candidate for a fixed object appearing in a video captured by the capturing device, and obtains a fixed-object area information item indicating coordinates of the fixed object candidate in the video, the fixed object having a fixed relative position with respect to the capturing device;
a storage that stores therein the fixed-object area information item obtained; and
an observer that determines the coordinates indicated by the fixed-object area information item to be coordinates of the fixed object in the video and outputs a determination result, the coordinates indicated by the fixed-object area information item matching coordinates indicated by a past fixed-object area information item stored in the storage in past.

2. The fixed object detector according to claim 1, further comprising:
a distance calculator that calculates a distance between the coordinates of the fixed object candidate indicated by the fixed-object area information item and coordinates of an other fixed object candidate indicated by an other fixed-object area information item, the fixed object candidate and the other fixed object candidate simultaneously appearing in the video; and
a combiner that updates, when the distance calculated by the distance calculator is less than a threshold, the coordinates indicated by the fixed-object area information item and the coordinates indicated by the other fixed-object area information item to updated coordinates indicated by a single fixed-object area information item,
wherein the fixed-object area information item stored in the storage is the single fixed-object area information item indicating the updated coordinates.

3. The fixed object detector according to claim 1, further comprising:
a fixed object notification device that notifies a user of the determination result output by the observer.

4. The fixed object detector according to claim 1,
wherein the observer executes:
a matching determination process of determining whether the coordinates indicated by the fixed-object area information item match the coordinates indicated by the past fixed-object area information item stored in the past;
a detection count recording process of making addition to a matching detection count of the fixed-object area information item indicating the coordinates determined to match in the matching determination process, and making subtraction from the matching detection count of the fixed-object area information item indicating the coordinates determined not to match in the matching determination process;
a fixed-object area information confirmation process of determining coordinates indicated by a fixed-object area information item, a matching detection count of which exceeds a first threshold count, to be the coordinates of the fixed object in the video; and
a fixed-object area information delete process of deleting a fixed-object area information item, a matching detection count of which is less than or equal to a second threshold count.

5. The fixed object detector according to claim 4,
wherein at least one of the first threshold count or the second threshold count is different for each of regions that result from dividing the video.

6. The fixed object detector according to claim 1,
wherein the observer infers the coordinates of the fixed object in the video, based on the past fixed-object area information item stored in the storage, and outputs an inference result as the determination result.

7. The fixed object detector according to claim 1,
wherein the observer executes a coordinate information determination process of determining whether the coordinates indicated by the fixed-object area information item are included in an excluded area that is preset in the video, and
for the fixed-object area information item indicating the coordinates determined not to be included in the excluded area in the coordinate information determination process, the observer determines whether the fixed-object area information item indicates the coordinates of the fixed object in the video.

8. The fixed object detector according to claim 1,
wherein the observer executes a color determination process of determining whether a display color at the coordinates indicated by the fixed-object area information item in the video corresponds to an excluded color that is preset, and
for the fixed-object area information item indicating the coordinates at which the display color in the video has been determined not to correspond to the excluded color in the color determination process, the observer determines whether the fixed-object area information item indicates the coordinates of the fixed object in the video.

9. The fixed object detector according to claim 1,
wherein the coordinates indicated by the fixed-object area information item include one-end coordinates and other-end coordinates of the fixed object candidate, the one-end coordinates and the other-end coordinates being on a one-end side and an other-end side in a predetermined direction, respectively, and
when a distance between one-end coordinates indicated by one fixed-object area information item and one-end coordinates indicated by an other fixed-object area information item is less than or equal to a one-end threshold and a distance between other-end coordinates indicated by the one fixed-object area information item and other-end coordinates indicated by the other fixed-object area information item is less than or equal to an other-end threshold, coordinates indicated by the one fixed-object area information item are determined to match coordinates indicated by the other fixed-object area information item.

10. The fixed object detector according to claim 1,
wherein the coordinates indicated by the fixed-object area information item include center coordinates that are coordinates at a center that bisects a line segment that connects a point on a one-end side of the fixed object candidate in a predetermined direction and a point on an other-end side of the fixed object candidate in the predetermined direction, and
when a distance between center coordinates indicated by one fixed-object area information item and center coordinates indicated by an other fixed-object area information item is less than or equal to a center threshold, coordinates indicated by the one fixed-object area information item are determined to match coordinates indicated by the other fixed-object area information item.

11. The fixed object detector according to claim 1,
wherein the coordinates indicated by the fixed-object area information item include one-end coordinates and other-end coordinates of the fixed object candidate, and center coordinates that are coordinates at a center that bisects a line segment that connects a point on a one-end side of the fixed object candidate in the predetermined direction and a point on an other-end side of the fixed object candidate in the predetermined direction, the one-end coordinates and the other-end coordinates being on the one-end side and the other-end side in the predetermined direction, respectively, and
when a distance between one-end coordinates indicated by one fixed-object area information item and one-end coordinates indicated by an other fixed-object area information item is less than or equal to a one-end threshold, a distance between other-end coordinates indicated by the one fixed-object area information item and other-end coordinates indicated by the other fixed-object area information item is less than or equal to an other-end threshold, and a distance between center coordinates indicated by the one fixed-object area information item and center coordinates indicated by the other fixed-object area information item is less than or equal to a center threshold, coordinates indicated by the one fixed-object area information item are determined to match coordinates indicated by the other fixed-object area information item.

12. The fixed object detector according to claim 1, further comprising:
an image quality adjusting device that receives input of an original video captured by the capturing device, and outputs a video having image quality adjusted to increase a probability of finding one or more fixed object candidates that include the fixed object candidate.

13. (canceled)

14. The fixed object detector according to claim 1, further comprising:
a reducer that reduces the video;
a feature detector that detects a feature from a reduced video resulting from the reducer reducing the video;
a feature storage that stores therein one or more features;
a cumulative adder that adds the feature detected by the feature detector and a prestored feature that is stored in advance in the feature storage, and stores a result of adding the feature detected and the prestored feature into the feature storage as an added feature;
a binarizer that binarizes the added feature stored;
a noise remover that removes noise included in data of the added feature binarized, by reducing and expanding the data of the added feature binarized; and
a labeler that generates the fixed-object area information item, based on the data of the added feature binarized from which the noise has been removed.

15. (canceled)

16. The fixed object detector according to claim 1,
wherein the fixed object is a raindrop on a light-transmitting member, the raindrop being within a capturing area of the capturing device, and
the fixed object candidate is a candidate for the raindrop.

17. (canceled)

18. The fixed object detector according to claim 1,
wherein the fixed object is a defect that includes at least one of a crack or a scratch generated in a light-transmitting member, the at least one of the crack or the scratch being within a capturing area of the capturing device, and
the fixed object candidate is a candidate for the defect.

19. The fixed object detector according to claim 1, further comprising:
a marker attached at a position corresponding to designated coordinates in the video;
a position tilt detector that measures a difference between the designated coordinates and coordinates of the marker indicated by the determination result output by the observer, the marker being the fixed object;
a position tilt correction device that corrects at least one of a position or a tilt of the video, based on the difference measured by the position tilt correction device; and
a display device that displays the video having the position and the tilt at least one of which has been corrected by the position tilt correction device.

20. The fixed object detector according to claim 1, further comprising:
a predictor that detects coordinates of a portion in which an edge shape that appears in the video captured by the capturing device is different from a predetermined shape; and
a determiner that determines the determination result is correct when the coordinates determined to be the coordinates of the fixed object in the determination result obtained by the observer match the coordinates detected by the predictor,
wherein the observer outputs the determination result determined to be correct by the determiner.

21. The fixed object detector according to claim 1, further comprising:
a reducer that reduces the video;
a feature detector that detects a feature from a reduced video resulting from the reducer reducing the video;
a feature storage that stores therein one or more features;
a cumulative adder that adds the feature detected by the feature detector and a prestored feature that is stored in advance in the feature storage, and stores a result of adding the feature detected and the prestored feature into the feature storage as an added feature;
a binarizer that binarizes the added feature stored; and
a straight line detector that detects, from data of the added feature binarized, coordinates of the fixed object candidate in a straight shape in the video, by using Hough transform that is a transform algorithm.

22. A fixed object detection method executed with use of a computer, the fixed object detection method comprising:
searching for a fixed object candidate that is a candidate for a fixed object appearing in a video captured by a capturing device, and obtaining a fixed-object area information item indicating coordinates of the fixed object candidate in the video, the fixed object having a fixed relative position with respect to the capturing device;
storing the fixed-object area information item obtained; and
determining that the coordinates indicated by the fixed-object area information item to be coordinates of the fixed object in the video and outputting a determination result, the coordinates indicated by the fixed-object area information item matching coordinates indicated by a past fixed-object area information item stored in past.

23. A non-transitory computer-readable recording medium having recorded thereon a program for causing the computer to execute the fixed object detection method according to claim 22.
